(19) United States
(12) Patent Application Publication
(10) Pub. No.: US 2026/0244607 A1
(43) Pub. Date: Aug. 20, 2026

(54) ESTIMATION DEVICE

(71) Applicant: NTT DOCOMO, INC., Tokyo (JP)

(72) Inventors: Ryoki WAKAMOTO, Tokyo (JP); Tsukasa DEMIZU, Tokyo (JP); Shigeki TANAKA, Tokyo (JP)

(73) Assignee: NTT DOCOMO, INC., Tokyo (JP)

(21) Appl. No.: 19/161,741

(22) PCT Filed: May 23, 2024
(86) PCT No.: PCT/JP2024/019094

§ 371 Date: Sep. 3, 2025

(30) Foreign Application Priority Data
May 23, 2023 (JP) 2023-084422

(51) Int. Cl. G06F 16/215

(52) U.S. Cl. CPC G06F 16/215

(57) ABSTRACT

An estimation device constructs a first estimation model and a second estimation model. The first estimation model estimates missing data within first table data on the basis of the first table data including first data indicating attributes of each user of a first user group. The second estimation model estimates missing data of a common user group within second table data on the basis of the first data with respect to the common user group in the second table data and the first table data. The estimation device estimates a value of the second data for the first user group excluding the common user group on the basis of the first estimation model and the second estimation model.

### TECHNICAL FIELD

The present disclosure relates to an estimation device.

### BACKGROUND ART

Patent Literature 1 discloses a data complementing technique. In this technique, a degree of correlation with other data items is calculated when there are missing data values in a plurality of data records and a complementing process based on a data value regression method is executed on the basis of data item values.

### CITATION LIST

### Patent Literature

[Patent Literature 1] Japanese Unexamined Patent Publication No. 2020-154828

### SUMMARY OF INVENTION

### Technical Problem

It is conceivable to integrate first table data in which first data of a first user group is stored and second table data in which second data of a second user group is stored with respect to the first user group and the second user group in which some users are common users. When there is missing data in the first table data and the second table data, a utility value of the integrated data can be reduced if the missing data remains in the integrated data. Moreover, when the first data and the second data have data items different from each other, it is possible to obtain integrated data for common users because there are the first data and the second data for the common users. However, for example, it is difficult to obtain integrated data for such users because there is no second data for the first user other than the common users.

The present disclosure has been made in view of the above circumstances and an objective of the present disclosure is to provide an estimation device that can accurately complement data.

### Solution to Problem

According to the present disclosure, an estimation device includes a first learning unit, a second learning unit, and an estimation unit. The first learning unit constructs a first estimation model. The first estimation model estimates missing data within first table data on the basis of the first table data including first data indicating attributes of each user of a first user group. The second learning unit constructs a second estimation model. The second estimation model estimates missing data for a common user group within second table data on the basis of the second table data and the first data for a common user group in the first table data. The second table data has second data indicating attributes of each user of the second user group having partially the same common user group as the first user group. The estimation unit estimates a value of the second data for the first user group excluding the common user group on the basis of the first estimation model and the second estimation model.

In the above-described estimation device, the missing data in the first table data is complemented by the first estimation model, and the missing data in the second table data is complemented by the second estimation model. Also, the second data for the first user other than the common user is complemented on the basis of the first estimation model and the second estimation model. The second estimation model for estimating the missing data within the second table data is constructed on the basis of the first data and the second data and the content of the first data is reflected. Therefore, the estimation unit, which estimates data on the basis of the first and second estimation models, can accurately estimate the second data that the first table data does not originally have.

### Advantageous Effects of Invention

According to the present disclosure, it is possible to accurately complement data.

### BRIEF DESCRIPTION OF DRAWINGS

FIG. 1 is a diagram showing an example of a configuration of an estimation device according to an embodiment of the present disclosure.

FIG. 2 is an explanatory diagram of content of first table data as an example.

FIG. 3 is an explanatory diagram of content of second table data as an example.

FIG. 4 is a diagram schematically showing a first estimation model as an example.

FIG. 5 is an explanatory diagram of content of integrated data as an example.

FIG. 6 is a diagram schematically showing a second estimation model as an example.

FIG. 7 is a diagram showing a hardware configuration of the estimation device as an example.

### DESCRIPTION OF EMBODIMENTS

Hereinafter, an embodiment of an estimation device according to the present disclosure will be described in detail with reference to the drawings. In addition, the same reference signs denote the same elements in description of the drawings and redundant description will be omitted.

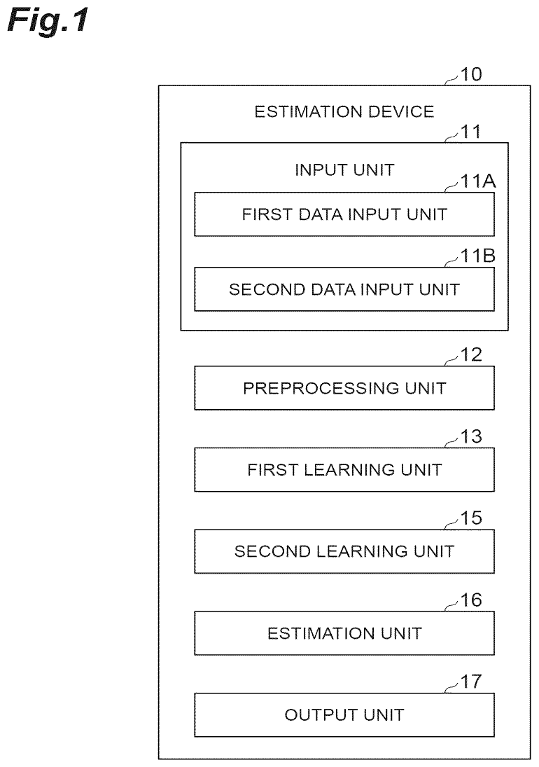

FIG. 1 is a diagram showing a configuration of an estimation device 10 as an example. As an example, the estimation device 10 can be used in a system to complement missing data and the like in the integrated table data when two table data items having attribute data items different from each other are integrated. Hereinafter, an example in which first table data and second table data are integrated will be described. The first table data is constituted by information about a first user group using a first service. The second table data is constituted by information about a second user group using a second service. In an example, the first and second services may be services in which points are awarded to the user in accordance with the purchase of goods by the user and the like, but the content of the first and second services is not limited thereto. The first user group using the first service and the second user group using the second service partially have the same common users as each other. In other words, the first user group includes users (common users) who also use the second service. In the present embodiment, for simplicity of description, it is assumed that all members of second user group are common users. For example, in a case where the company operating the first service is a host company and the company operating the second service is a partner company, an example in which the estimation device 10 is used by the host company when the partner company provides the second table data for only common users will be described.

As shown in FIG. 1, as an example, the estimation device 10 includes an input unit 11, a preprocessing unit 12, a first learning unit 13, a second learning unit 15, an estimation unit 16, and an output unit 17. The input unit 11 includes a first data input unit 11A and a second data input unit 11B. The content of the first table data in which the data (first data) of the first user group using the first service is stored is input to the first data input unit 11A. The first table data may be managed by the host company. The content of the data for the common user group in the second table data is input to the second data input unit 11B. In the present embodiment, the content of the second table data may be input to the second data input unit 11B as it is, because the entire second user group constituting the second table data is common users. The second table data may be managed by the partner company. For example, the second data may be data extracted for common users from the second table data managed by the partner company.

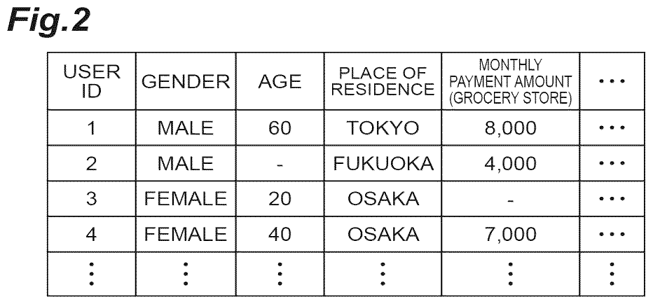

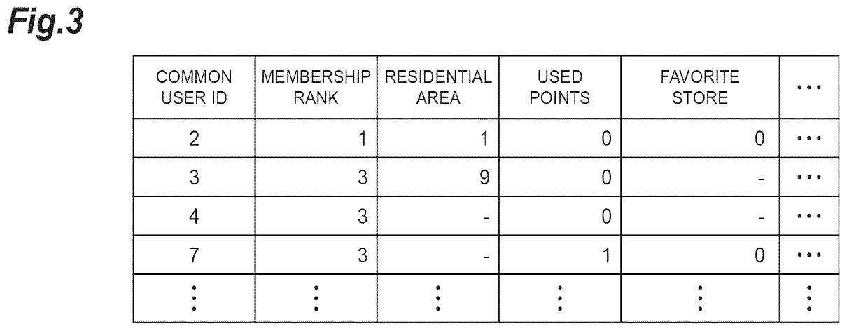

FIG. 2 is a diagram showing content of the first table data. FIG. 3 is a diagram showing content of the second table data. As an example, the first data includes a user ID (identifier) for identifying the user and attribute data for each user. The user's attribute data may include basic information and behavioral information. The basic information may include static features such as the user's gender, age, and place of residence. In addition, the basic information may be based on contract information acquired from the user at the start of use of the first service. The behavioral information includes a dynamic feature resulting from the user's behavior, such as a payment amount of the user related to the first service. The behavioral information may include a plurality of behavioral histories with features different from each other. In the example in FIG. 2, the age item for the user whose user ID is 2 and the payment amount item for the user whose user ID is 4 are missing data and are indicated by “-.”

In addition, the behavioral information of the user may be acquired via an application operating on a terminal device. The terminal device is a communication device that is operated by a user. The terminal device may be, for example, a portable terminal such as a high-function portable phone (a smartphone), a portable phone, or a personal digital assistant (PDA). In addition, a device constituting the terminal device is not to be construed in a restrictive manner.

As an example, the second data includes a common user ID for identifying a common user and data about each user's attribute. The common user ID may have the same identification code as the user ID of the first data. In addition, the user ID (the common user ID) may be personally identifiable information such as an e-mail address or a portable phone number. In this case, a user having a common user ID included in each of the first table data and the second table data can be extracted as a common user. In the example shown in FIG. 3, the users whose user IDs are 2, 3, 4, and 7 in the first user group constituting the first table data are exemplified as the common users. Moreover, in the example shown in FIG. 3, the item of the favorite store of the user whose common user ID is 3, the items of the residential area and favorite store of the user whose user ID is 4, and the item of the residential area of the user whose user ID is 7 are all missing data and indicated by “-.”

In the second data, the user's attributes may include basic information and behavioral information. The basic information includes a static feature such as the user's residential area. In addition to the residential area, the basic information can include gender and the like as in the first data. In this example, basic information redundant with that of the first data included in the second table data may be deleted before being input to the second data input unit 11B. The behavioral information includes dynamic features resulting from the behavior of the user, such as the user's membership rank in the second service, used points, and favorite stores.

The preprocessing unit 12 performs a process of converting the first data input to the first data input unit 11A and the second data input to the second data input unit 11B into a format that can be processed by the first learning unit 13 and the second learning unit 15. As an example, the preprocessing unit 12 may convert character string data included in the first and second data into numerical data.

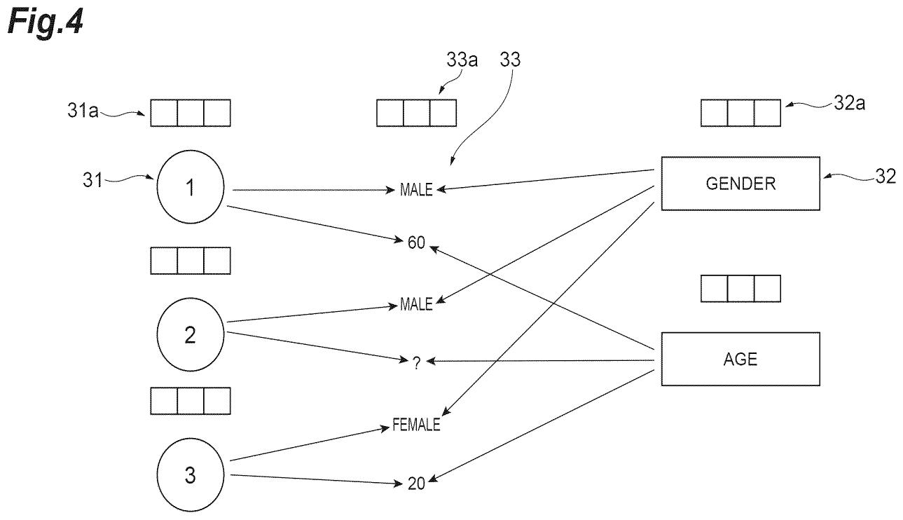

Moreover, the preprocessing unit 12 also represents the input table data in a graph space. FIG. 4 schematically shows an example in which the first table data is represented in the graph space as an example of table data represented in the graph space. The table data in the present embodiment includes a user ID for identifying each user and a value of each item in the data column associated with the user ID. Therefore, the preprocessing unit 12 represents the user and each data column item as a node. In FIG. 4, each user ID is represented as a node 31 surrounded by a circle, and each item is represented as a node 32 surrounded by a square. The preprocessing unit 12 connects the corresponding user's node 31 with the item's node 32, using the value of the item as an edge 33. The preprocessing unit 12 performs the embedded representation of the nodes 31 and 32 and the edge 33 so that users, items and values are represented by vectors. Hereinafter, a vector 31a of the user generated by the embedded representation is referred to as a feature vector, a vector 32a of the item is referred to as a variable vector, and a vector 33a of the value is referred to as a weight vector.

The preprocessing unit 12 represents the first table data in the graph space as a preprocessing step for model construction in the first learning unit 13. Moreover, as a preprocessing step for model construction in the second learning unit 15, the preprocessing unit 12 represents the table data (common table data) in which the first data and the second data for the common user group are integrated in the graph space.

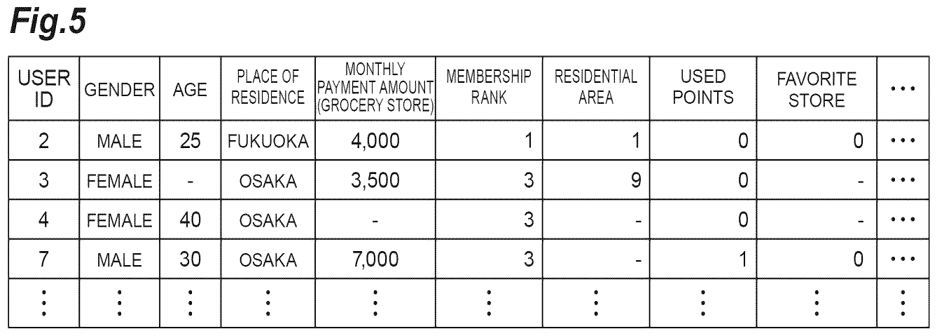

For example, the preprocessing unit 12 may generate common table data in which the first data of the common user group constituting the first table data and the second data of the common user group constituting the second table data are integrated, and represent the generated common table data in the graph space. FIG. 5 is a diagram showing the content of the common table data. As an example, the common table data includes user IDs and data about attributes of each user. The user's attributes include basic information and behavioral information in the first data and basic information and behavioral information in the second data. Although data about common users of the first data shown in FIG. 2 and the second data shown in FIG. 3 are integrated as they are for ease of understanding in FIG. 5, data converted into numerical data by the preprocessing unit 12 may be used.

The first learning unit 13 constructs a first estimation model using a deep learning technique with a neural network (here, a graph neural network) using the first table data in the graph space processed by the preprocessing unit 12 as learning data. For example, the first learning unit 13 constructs a learning model for estimating the value of each item from the feature vector and the variable vector by repeating learning using each user's data while updating an initial value given to the feature vector and the variable vector in the preprocessing unit 12 on the basis of an adjacency matrix representing a positional relationship between the user's node and the item's node, a feature vector representing the feature of the user, a variable vector representing the feature of the item, and a weight vector representing a feature of the value. That is, the first estimation model learned by the first learning unit 13 has a feature vector and a variable vector for estimating the value of each item in the first table data.

The second learning unit 15 constructs a second estimation model using deep learning techniques with a neural network by designating the common table data in the graph space processed by the preprocessing unit 12 as learning data. The learning technique in the second learning unit 15 may be the same as that in the first learning unit 13. In other words, the model learned by the second learning unit 15 has a feature vector and a variable vector for estimating the value of each item in the common table data.

The estimation unit 16 estimates the missing data in the first table data and generates the first table data in which the missing data is complemented. As an example, the estimation unit 16 may complement missing data in the first table data using the first estimation model constructed by the first estimation model. In other words, the estimation unit 16 may acquire the feature vector of the user and the variable vector of the item corresponding to the missing data in the first table data from the first estimation model. The estimation unit 16 may estimate the missing data in the first table data on the basis of the feature vector and the variable vector that have been acquired. In addition, the common table data used in the second learning unit 15 described above may be generated on the basis of the first table data in which the missing data is complemented by the first estimation model.

The estimation unit 16 may complement the missing data in the first table data using the second estimation model constructed by the second estimation model. In other words, the estimation unit 16 may acquire the feature vector of the user and the variable vector of the item corresponding to the missing data in the first table data from the second estimation model. The estimation unit 16 may estimate the missing data in the first table data on the basis of the feature vector and the variable vector that have been acquired. In addition, the estimation unit 16 may complement the missing data in the first table data using an average value between an estimated value estimated by the first estimation model and an estimated value estimated by the second estimation model.

Moreover, the estimation unit 16 estimates missing data in the common table data and generates the common table data in which the missing data is complemented. In other words, the estimation unit 16 may acquire the feature vector of the user and the variable vector of the item corresponding to the missing data in the common table data from the second estimation model. The estimation unit 16 may estimate the missing data in the common table data on the basis of the feature vector and the variable vector that have been acquired.

The estimation unit 16 estimates the second data for the first user group other than common users in the first table data. In other words, in the illustrated example, membership ranks and the like are estimated for users with user IDs of 1, 5, 6, and the like. As an example, the estimation unit 16 may estimate the second data for the first user group other than common users in the first table data using the first and second estimation models. The estimation unit 16 may acquire a feature vector corresponding to each user of the first user group other than common users in the first table data from the first estimation model and acquire a variable vector of an item corresponding to the second data from the second estimation model. The estimation unit 16 may estimate the second data for the first user group on the basis of the feature vector and the variable vector that have been acquired.

The output unit 17 outputs integrated table data including the first and second data for the first user group. Missing data in the first data constituting the integrated data table may be complemented by the estimation unit 16. Missing data in the second data for common users constituting the integrated data table may be complemented by the estimation unit 16. The second data of the first user group constituting the integrated data table may be data estimated by the estimation unit 16. In addition, the output unit 17 may output the first table data in which missing data is complemented or the second table data in which missing data is complemented.

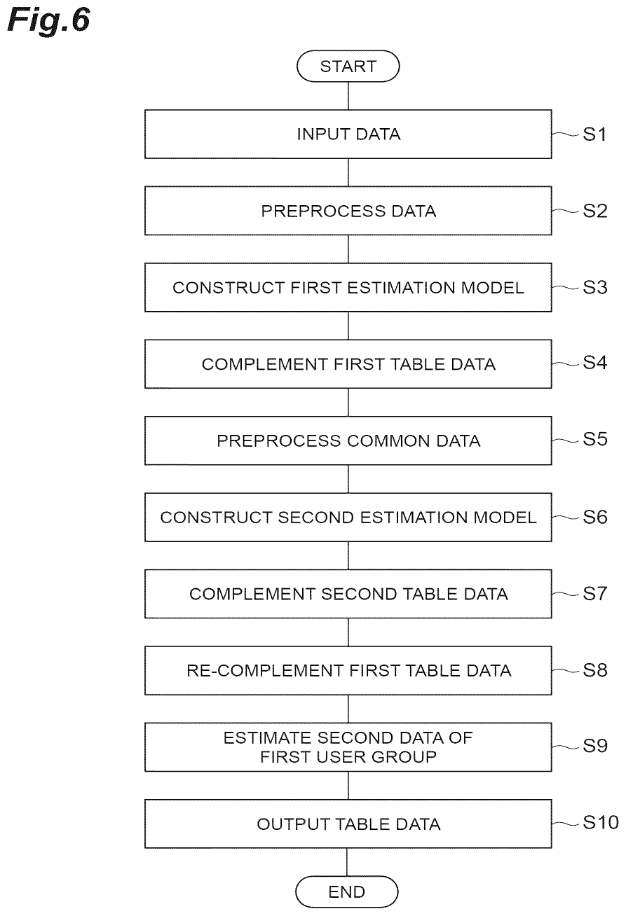

FIG. 6 is a flowchart showing an operation of the estimation device 10 in an example. First, in the estimation device 10, data constituting first table data and data constituting second table data are input to the input unit 11 (step S1). The second table data may include users other than common users, but here it is assumed that the second table data includes only common users.

Subsequently, the first data constituting the first table data is preprocessed (step S2). In other words, the preprocessing unit 12 represents the first table data in a graph space. Subsequently, the first learning unit 13 constructs a first estimation model on the basis of the preprocessed first table data (step S3). Subsequently, the estimation unit 16 complements missing data in the first table data (step S4). In other words, the estimation unit 16 complements the missing data in the first table data using a feature vector and a variable vector of the first estimation model constructed in the first learning unit 13.

Subsequently, common data is preprocessed (step S5). First, the preprocessing unit 12 extracts common user data between the first table data and the second table data to generate common table data. The missing data in the first table data is complemented in step S4. Subsequently, the preprocessing unit 12 represents the generated common table data in the graph space. Subsequently, the second learning unit 15 constructs a second estimation model on the basis of the preprocessed common table data (step S6).

Subsequently, the estimation unit 16 complements missing data in the second table data (step S7). In other words, the estimation unit 16 complements the missing data in the second table data using a feature vector and a variable vector of the second estimation model constructed by the second learning unit 15.

Subsequently, the estimation unit 16 re-complements the missing data in the first table data (step S8). For example, the estimation unit 16 estimates the missing data in the first table data using the feature vector of the first estimation model and the variable vector of the second estimation model, and complements the missing data by taking an average between this estimated missing data and the missing data estimated in step S4. In addition, the first data for common users in the first table data may be complemented using the feature vector and the variable vector of the second estimation model constructed in the second learning unit 15.

Subsequently, the estimation unit 16 estimates the second data for the first user group (step S9). In other words, the estimation unit 16 estimates the second data for the first user group excluding common users using the feature vector of the first estimation model and the variable vector of the second estimation model.

Subsequently, the output unit 17 outputs the integrated table data in which the missing data and the second data for the first user group have been complemented by the estimation unit 16. In an example, missing data in a first table data portion is complemented in step S8, missing data in a second table data portion is complemented in step S7, and the second data for the first user group excluding the common users is estimated in step S9.

As described above, as the example, the estimation device 10 includes the first learning unit 13 configured to construct a first estimation model for estimating missing data within the first table data on the basis of the first table data, the second learning unit 15 configured to construct a second estimation model for estimating missing data of a common user group within second table data on the basis of the second data for the common user group in the second table data and the first data for the common user group in the first table data, and the estimation unit 16 configured to estimate a value of the second data for the first user group excluding the common user group on the basis of the first estimation model and the second estimation model.

In the above-described estimation device 10, the first estimation model complements missing data in the first table data, and the second estimation model complements missing data in the second table data. Also, the second data for the first user other than the common user is complemented on the basis of the first estimation model and the second estimation model. The second estimation model for estimating missing data within the second table data is constructed on the basis of the first and second data and the content of the first data is reflected. Therefore, the estimation unit 16, which estimates missing data on the basis of the first and second estimation models, can accurately estimate the second data that the first table data does not originally have.

As an example, the first estimation model may estimate a value of each item corresponding to each user of the first user group from a feature quantity of each user of the first user group and a feature quantity of each item constituting the first table data. As an example, the second estimation model may estimate a value of each item corresponding to each user of the common user group from a feature quantity of each user of the common user group and a feature quantity of each item constituting the second table data. As an example, the estimation unit 16 may estimate the value of the second data for the first user group excluding the common user group on the basis of a feature quantity of each user of the first user group used in the first estimation model and a feature quantity of each item constituting the second table data used in the second estimation model. In this configuration, when the second data of the first user group is estimated, the data of the first table data is reflected in the feature quantity of the user and the data of the common user of the first table data and the second table data is reflected in the feature quantity of the item of the second data. In this case, because the feature quantity of the user is generated by the first table data constituted by the first user group having a larger number of users than the common user group, bias is unlikely to occur in the feature of the user. Moreover, because the feature quantities of the items of the second data are generated on the basis of the first and second data of the common user group, the feature quantity can be generated with high accuracy compared to the case where the feature quantity of the item of the second data is generated on the basis of only the second data of the common user group. Therefore, it is possible to accurately estimate the second data that the first table data does not originally have on the basis of the feature quantity of the first user and the feature quantity of the item of the second data.

As an example, the feature quantity of each user of the first user group used in the first estimation model and the feature quantity of each item constituting the second table data used in the second estimation model may be represented by vectors. In this configuration, the construction of estimation models is facilitated using so-called graph neural network techniques.

As an example, the second estimation model may estimate missing data within the first table data on the basis of the first data and the second data for the common user group. In this configuration, missing data can be estimated more accurately than in the first estimation model due to the increase in the number of items, which are data columns.

As an example, the second learning unit 15 may construct the second estimation model on the basis of the first table data and the second table data in which the missing data is complemented by the first estimation model. In this configuration, it is possible to construct a second estimation model with high estimation accuracy using the first table data in which missing data is complemented.

Although an embodiment has been described in detail above with reference to the drawings, specific configurations are not limited to the embodiment. For example, an example in which a learning model is constructed with a deep learning technique using a graph neural network has been described, but other machine learning techniques may be used as long as the second data for the first user can be estimated on the basis of a feature of the first user estimated from the first estimation model and a feature of the item of the second data estimated from the second estimation model.

The block diagrams that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate pieces of apparatus (for example, via wire, wireless, or the like) and using these plurality of pieces of apparatus. The functional blocks may be implemented by combining software into the apparatus described above or the plurality of apparatuses described above.

Functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but function are by no means limited to these. For example, functional block (components) to implement a function of transmission may be referred to as a “transmitting section (transmitting unit),” a “transmitter,” and the like. The method for implementing each component is not particularly limited as described above.

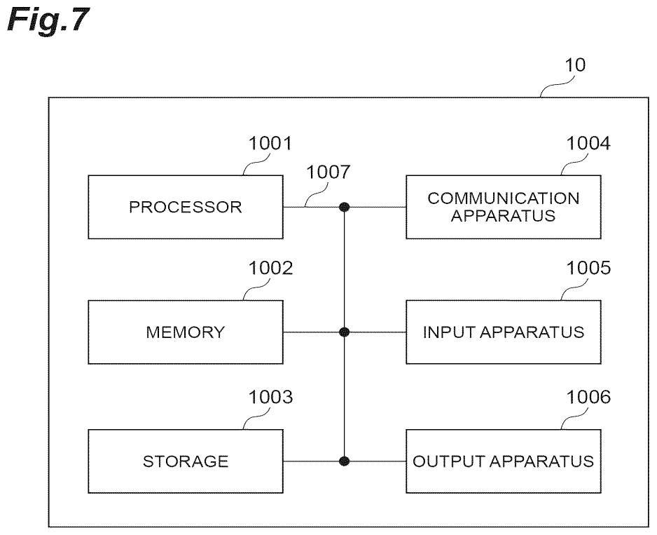

For example, the estimation device 10 according to one embodiment of the present disclosure may function as a computer that executes the processes of the radio communication method of the present disclosure. FIG. 7 is a diagram to show an example of a hardware structure of the estimation device 10 according to one embodiment. Physically, the above-described the estimation device 10 may each be formed as a computer apparatus that includes a processor 1001, a memory 1002, a storage 1003, a communication apparatus 1004, an input apparatus 1005, an output apparatus 1006, a bus 1007, and so on.

Note that in the present disclosure, the words such as an apparatus, a circuit, a device, a section, a unit, and so on can be interchangeably interpreted. The hardware structure of the input unit 11, the preprocessing unit 12, the first learning unit 13, the second learning unit 15, the estimation unit 16, and the output unit 17 may be configured to include one or more of apparatuses shown in the drawings, or may be configured not to include part of apparatuses.

Each function of the estimation device is implemented, for example, by allowing certain software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, at least part of the above-described the preprocessing unit 12, the first learning unit 13, the second learning unit 15, the estimation unit 16, and so on may be implemented by the processor 1001.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least part of the operations of the above-described embodiments are used. For example, the preprocessing unit 12 may be implemented by control programs that are stored in the memory 1002 and that operate on the processor 1001, and other functional blocks may be implemented likewise. The various processes have been described to be performed by a single processor 1001. However, the processes may be performed by two or more processors 1001 simultaneously or sequentially. The processor 1001 may be implemented by one or more chips. It should be noted that the program may be transmitted from a network via a telecommunication line.

The memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAM), and other appropriate storage media. The memory 1002 may be referred to as a “register,” a “cache,” a “main memory (primary storage apparatus)” and so on. The memory 1002 can store executable programs (program codes), software modules, and the like for implementing the radio communication method according to one embodiment of the present disclosure.

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “auxiliary storage apparatus.” The above recording medium may be a database including the memory 1002 and/or the storage 1003, a server, or any other appropriate medium.

The communication apparatus 1004 is hardware (transmitting/receiving device) for allowing inter-computer communication via at least one of wired and wireless networks, and may be referred to as, for example, a “network device,” a “network controller,” a “network card,” a “communication module,” and so on. The communication apparatus 1004 may be configured to include a high frequency switch, a duplexer, a filter, a frequency synthesizer, and so on in order to realize, for example, at least one of frequency division duplex (FDD) and time division duplex (TDD). For example, the input unit 11, the output unit 17, and the like, may be implemented by the communication device 1004.

The input apparatus 1005 is an input device that receives input from the outside (for example, a keyboard, a mouse, a microphone, a switch, a button, a sensor, and so on). The output apparatus 1006 is an output device that allows sending output to the outside (for example, a display, a speaker, a Light Emitting Diode (LED) lamp, and so on). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between pieces of apparatus.

Also, the estimation device may be structured to include hardware such as a microprocessor, a digital signal processor (DSP), an Application Specific Integrated Circuit (ASIC), a Programmable Logic Device (PLD), a Field Programmable Gate Array (FPGA), and so on, and part or all of the functional blocks may be implemented by the hardware. For example, the processor 1001 may be implemented with at least one of these pieces of hardware.

Notification of information is by no means limited to the aspects/embodiments described in the present disclosure, and other methods may be used as well. For example, notification of information in the present disclosure may be implemented by using physical layer signaling (for example, downlink control information (DCI), uplink control information (UCI)), higher layer signaling (for example, Radio Resource Control (RRC) signaling, broadcast information (master information block (MIB), system information block (SIB), and so on), Medium Access Control (MAC) signaling), and other signals or combinations of these. Also, RRC signaling may be referred to as an “RRC message,” and can be, for example, an RRC connection setup message, an RRC connection reconfiguration message, and so on.

The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

The input or output information may be stored in a specific location (e.g., memory) or managed using management tables. The input or output information may be overwritten, updated, or added. The information that has been output may be deleted. The information that has been input may be transmitted to another apparatus.

A decision or a determination in an embodiment of the present invention may be realized by a value (0 or 1) represented by one bit, by a boolean value (true or false), or by comparison of numerical values (e.g., comparison with a predetermined value).

Each aspect/embodiment described in the present specification may be used independently, may be used in combination, or may be used by switching according to operations. Further, notification (transmission/reporting) of predetermined information (e.g., notification (transmission/reporting) of “X”) is not limited to an explicit notification (transmission/reporting), and may be performed by an implicit notification (transmission/reporting) (e.g., by not performing notification (transmission/reporting) of the predetermined information).

As described above, the present invention has been described in detail. It is apparent to a person skilled in the art that the present invention is not limited to one or more embodiments of the present invention described in the present specification. Modifications, alternatives, replacements, etc., of the present invention may be possible without departing from the subject matter and the scope of the present invention defined by the descriptions of claims. Therefore, the descriptions of the present specification are for illustrative purposes only, and are not intended to be limitations to the present invention.

Software should be broadly interpreted to mean, whether referred to as software, firmware, middle-ware, microcode, hardware description language, or any other name, instructions, instruction sets, codes, code segments, program codes, programs, subprograms, software modules, applications, software applications, software packages, routines, subroutines, objects, executable files, executable threads, procedures, functions, and the like.

Further, software, instructions, information, and the like may be transmitted and received via a transmission medium. For example, in the case where software is transmitted from a website, server, or other remote source using at least one of wired line technologies (such as coaxial cable, fiber optic cable, twisted pair, digital subscriber line (DSL), etc.) or wireless technologies (infrared, microwave, etc.), at least one of these wired line technologies or wireless technologies is included within the definition of the transmission medium.

Information, a signal, or the like, described in the present specification may be represented by using any one of various different technologies. For example, data, an instruction, a command, information, a signal, a bit, a symbol, a chip, or the like, described throughout the present application, may be represented by a voltage, an electric current, electromagnetic waves, magnetic fields, a magnetic particle, optical fields, a photon, or a combination thereof.

It should be noted that a term used in the present specification and/or a term required for understanding of the present specification may be replaced by a term having the same or similar meaning.

Further, the information, parameters, and the like, described in the present disclosure may be expressed using absolute values, relative values from predetermined values, or they may be expressed using corresponding different information. For example, a radio resource may be what is indicated by an index.

As used herein, the term “determining” may encompasses a wide variety of actions. For example, “determining” may be regarded as judging, calculating, computing, processing, deriving, investigating, looking up (e.g., looking up in a table, a database or another data structure), ascertaining and the like. Also, “determining” may be regarded as receiving (e.g., receiving information), transmitting (e.g., transmitting information), inputting, outputting, accessing (e.g., accessing data in a memory) and the like. Also, “determining” may be regarded as resolving, selecting, choosing, establishing and the like. That is, “determining” may be regarded as a certain type of action related to determining.

The term “connected” or “coupled” or any variation thereof means any direct or indirect connection or connection between two or more elements and may include the presence of one or more intermediate elements between the two elements “connected” or “coupled” with each other. The coupling or connection between the elements may be physical, logical, or a combination thereof. For example, “connection” may be read as “access”. As used in the present disclosure, the two elements may be thought of as being “connected” or “coupled” to each other using at least one of the one or more wires, cables, or printed electrical connections and, as a number of non-limiting and non-inclusive examples, electromagnetic energy having wavelengths in the radio frequency region, the microwave region, and the light (both visible and invisible) region.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

Reference to elements with designations such as “first,” “second,” and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

In the case where the terms “include”, “including” and variations thereof are used in the present disclosure, these terms are intended to be comprehensive in the same way as the term “comprising”. Further, the term “or” used in the present specification is not intended to be an “exclusive or”.

In the present disclosure, where an article is added by translation, for example “a”, “an”, and “the”, the disclosure may include that the noun following these articles is plural.

In this disclosure, the term “A and B are different” may mean “A and B are different from each other.” It should be noted that the term “A and B are different” may mean “A and B are different from C.” Terms such as “separated” or “combined” may be interpreted in the same way as the above-described “different”.

The estimation device of the present disclosure has the following configurations.
[1] An estimation device comprising:
   a first learning unit configured to construct a first estimation model for estimating missing data within first table data on the basis of the first table data including first data indicating attributes of each user of a first user group;
   a second learning unit configured to construct a second estimation model for estimating missing data of a common user group within second table data on the basis of the second table data having second data indicating attributes of each user of a second user group having partially the same common user group as the first user group and the first data for the common user group in the first table data; and
   an estimation unit configured to estimate a value of the second data for the first user group excluding the common user group on the basis of the first estimation model and the second estimation model.
[2] The estimation device according to [1],
   wherein the first estimation model estimates a value of each item corresponding to each user of the first user group from a feature quantity of each user of the first user group and a feature quantity of each item constituting the first table data,
   wherein the second estimation model estimates a value of each item corresponding to each user of the common user group from a feature quantity of each user of the common user group and a feature quantity of each item constituting the second table data, and
   wherein the estimation unit estimates the value of the second data for the first user group excluding the common user group on the basis of a feature quantity of each user of the first user group used in the first estimation model and a feature quantity of each item constituting the second table data used in the second estimation model.
[3] The estimation device according to [2], wherein the feature quantity of each user of the first user group used in the first estimation model and the feature quantity of each item constituting the second table data used in the second estimation model are represented by vectors.
[4] The estimation device according to any one of [1] to [3], wherein the second estimation model estimates missing data within the first table data on the basis of the first data and the second data for the common user group.
[5] The estimation device according to any one of [1] to [4], wherein the second learning unit constructs the second estimation model on the basis of the first table data and the second table data in which the missing data is complemented by the first estimation model.

### REFERENCE SIGNS LIST

10 Estimation device, 11 Input unit, 11A First data input unit, 11B Second data input unit, 12 Preprocessing unit, 13 First learning unit, 15 Second learning unit, 16 Estimation unit, 17 Output unit, 1001 Processor, 1002 Memory, 1003 Storage, 1004 Communication apparatus, 1005 Input apparatus, 1006 Output apparatus, 1007 Bus

1. An estimation device comprising:
a first learning unit configured to construct a first estimation model for estimating missing data within first table data based on the first table data including first data indicating attributes of each user of a first user group;
a second learning unit configured to construct a second estimation model for estimating missing data of a common user group within second table data based on the second table data having second data indicating attributes of each user of a second user group having partially the same common user group as the first user group and the first data for the common user group in the first table data; and
an estimation unit configured to estimate a value of the second data for the first user group excluding the common user group based on the first estimation model and the second estimation model.

2. The estimation device according to claim 1,
wherein the first estimation model estimates a value of each item corresponding to each user of the first user group from a feature quantity of each user of the first user group and a feature quantity of each item constituting the first table data,
wherein the second estimation model estimates a value of each item corresponding to each user of the common user group from a feature quantity of each user of the common user group and a feature quantity of each item constituting the second table data, and
wherein the estimation unit estimates the value of the second data for the first user group excluding the common user group based on a feature quantity of each user of the first user group used in the first estimation model and a feature quantity of each item constituting the second table data used in the second estimation model.

3. The estimation device according to claim 2, wherein the feature quantity of each user of the first user group used in the first estimation model and the feature quantity of each item constituting the second table data used in the second estimation model are represented by vectors.

4. The estimation device according to claim 1, wherein the second estimation model estimates missing data within the first table data based on the first data and the second data for the common user group.

5. The estimation device according to claim 1, wherein the second learning unit constructs the second estimation model based on the first table data and the second table data in which the missing data is complemented by the first estimation model.

6. An estimation device comprising:
a first learning unit configured to construct a first estimation model for estimating missing data within first table data based on the first table data including first data indicating attributes of each user of a first user group; and
a second learning unit configured to construct a second estimation model for estimating missing data of a common user group within second table data based on the second table data having second data indicating attributes of each user of a second user group having partially the same common user group as the first user group and the first data for the common user group in the first table data in which the missing data is complemented by the first estimation model.
